(19) United States
(12) Patent Application Publication
(10) Pub. No.: US 2002/0168449 A1
(43) Pub. Date: Nov. 14, 2002

(54) Flavored sheet product adapted for folding to create a three-dimensional design

(76) Inventor: Ethan Summers, Charlotte, NC (US)

Correspondence Address: Adams, Schwartz & Evans, P.A., 2180 Two First Union Center, Charlotte, NC, 28282, US

(21) Appl. No.: 09/853,242

(22) Filed: May 11, 2001

(51) Int. Cl. A23L 1/00

(52) U.S. Cl. 426/87

(57) ABSTRACT

A flavored sheet product is adapted for being folded to create a three-dimensional design. The product includes a generally flat sheet of edible or chewable flavored substance having sufficient flexibility to be folded. The sheet is adapted for retaining the fold in a three-dimensional design. Indicia is applied to the sheet indicating where the folds should be made in order to create the three-dimensional design.

### BACKGROUND OF THE INVENTION

This invention relates to a flavored sheet product adapted for folding to create a three-dimensional design. The invention is relatively inexpensive to manufacture, and is both entertaining and educational for children. The invention teaches children the Japanese art of origami folding, and encourages them to read and follow instructions.

### BRIEF SUMMARY OF THE INVENTION

Therefore, it is an object of the invention to provide a flavored sheet product adapted for folding to create a three-dimensional design.

It is another object of the invention to provide a flavored sheet product which is both entertaining and educational for children.

It is another object of the invention to provide a flavored sheet product which is especially adapted for origami folding.

It is another object of the invention to provide a flavored sheet product which is relatively inexpensive to manufacture.

These and other objects of the present invention are achieved in the preferred embodiments disclosed below by providing a flavored sheet product adapted for being folded to create a three-dimensional design. The product includes a generally flat sheet of edible or chewable flavored substance having sufficient flexibility to be folded. The sheet is adapted for retaining the fold in a three-dimensional design. Indicia is applied to the sheet indicating where the folds should be made in order to create the three-dimensional design.

According to another preferred embodiment of the invention, the flavored substance is chewing gum.

According to another preferred embodiment of the invention, the flavored substance is a food product.

According to another preferred embodiment of the invention, the indicia includes a printed fold line.

According to another preferred embodiment of the invention, the fold line is broken.

According to another preferred embodiment of the invention, the fold line is solid.

According to another preferred embodiment of the invention, the indicia is applied by screen printing.

According to another preferred embodiment of the invention, the indicia is applied by press printing.

According to another preferred embodiment of the invention, the indicia is edible ink.

According to another preferred embodiment of the invention, the indicia includes a character face.

According to another preferred embodiment of the invention, the sheet has at least one die cut to facilitate folding.

According to another preferred embodiment of the invention a separate instruction sheet is provided to demonstrate the fold necessary to create the three-dimensional design.

### BRIEF DESCRIPTION OF THE SEVERAL VIEWS OF THE DRAWINGS

Some of the objects of the invention have been set forth above. Other objects and advantages of the invention will appear as the description proceeds when taken in conjunction with the following drawings, in which:

FIG. 1 is a top plan view of an edible or chewable, flavored sheet product according to one preferred embodiment of the invention, and showing the sheet product prior to folding into a three-dimensional character;

FIG. 2 is a perspective view of a three-dimensional character created using the flavored sheet product; and

FIGS. 3a-3g are sequential views demonstrating the folding process for creating the three-dimensional character.

### DETAILED DESCRIPTION OF THE INVENTION

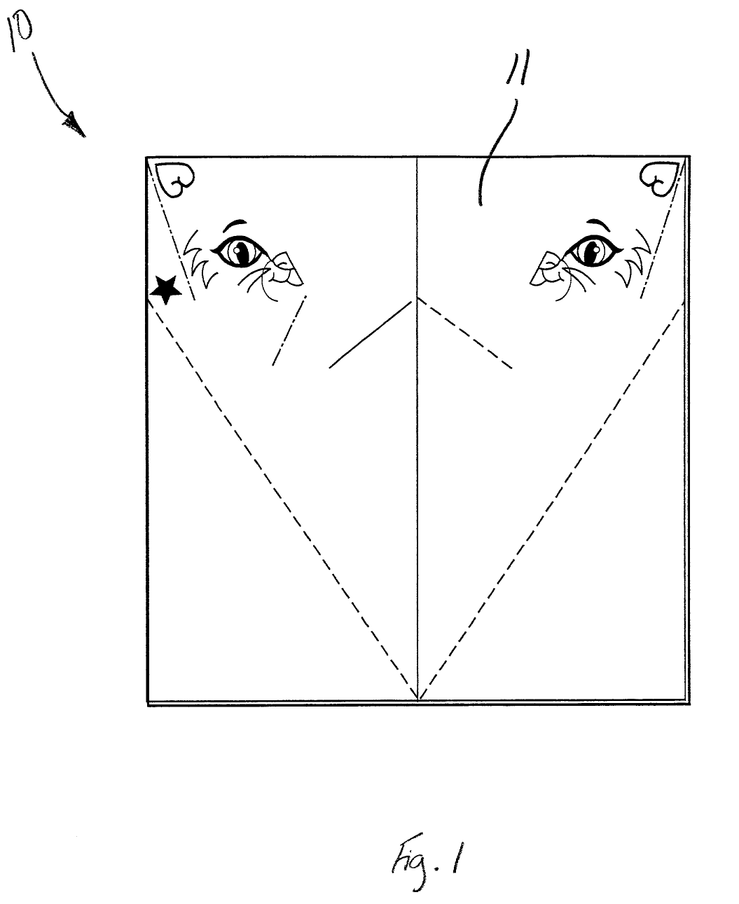

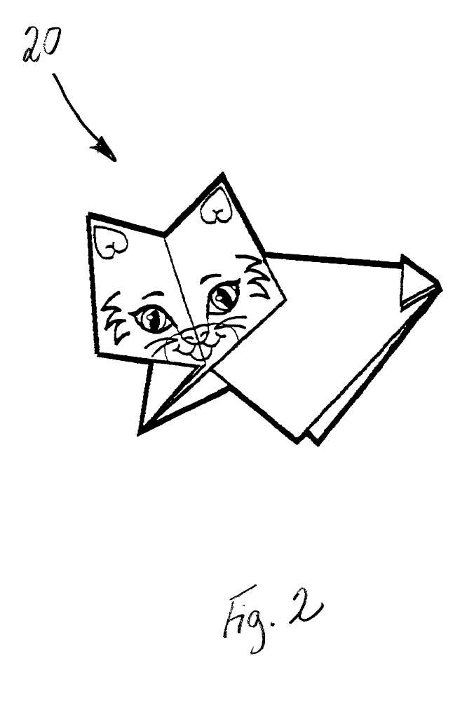

Referring now specifically to the drawings, a flavored sheet product according to the present invention is illustrated in FIG. 1 and shown generally at reference numeral 10. The sheet product 10 is formed of a generally flat sheet 11 of edible or chewable substance having sufficient flexibility to be folded, and adapted for retaining its fold in a three-dimensional design 20, such as shown in FIG. 2. The flavored substance is preferably chewing gum. In other embodiments, the flavored substance may be any suitable food product formed in a flexible sheet. Indicia, such as a character face and/or broken and solid fold lines and/or written instructions, are preprinted on the sheet 11 to indicate the folds necessary to create the intended design 20. One or more die cuts may also be made in the sheet 11 to facilitate folding. The indicia applied to the sheet 11 is preferably an edible ink made of food coloring. The indicia may be applied using any suitable means, such as by screen printing or press printing.

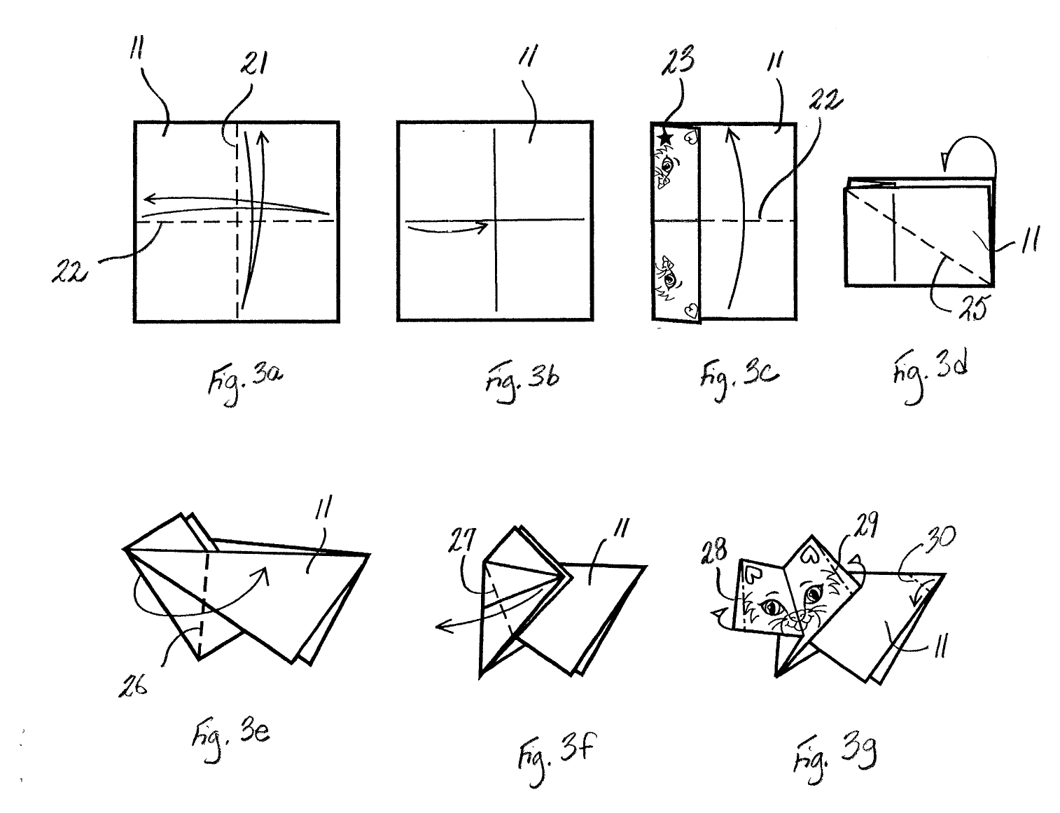

Referring to FIGS. 3a-3g, the three-dimensional design 20 is created by first placing the sheet 11 image-side down on a flat supporting surface. The sheet 11 is then folded in quarters along intersecting broken fold lines 21 and 22, as indicated in FIG. 3a. The left side edge of the sheet is folded to the center, as indicated in FIG. 3b, to reveal the eyes of the character with the orientation star 23 in the upper left corner, as shown in FIG. 3c. The sheet 11 is then folded inwardly in half along the fold line 22. The outside flaps of the sheet 11 are then folded downwardly along respective fold lines 25 (only one shown), as indicated in FIG. 3d, to the position shown in FIG. 3e. Both flaps of the sheet 11 are then folded at fold line 26 to the position shown in FIG. 3f. The outer flap is then folded outwardly at fold line 27 to reveal the face of the character. Final folds are made at lines 28, 29, and 30 to finish the face and tale. The result is a three-dimensional cat character 20 which can now be eaten or chewed. The sheet product 10 is preferably packaged and sold with a written instruction sheet and drawings, such as those provided in FIGS. 3a-3g and described above.

In another embodiment of the invention, the sheet product may include cut-out characters adapted for being folded around the finger of a user to create an edible or chewable finger puppet. Any number of other designs or characters may be created using the concept of the present invention.

A flavored sheet product adapted for being folded to create a three-dimensional design is described above. Various details of the invention may be changed without departing from its scope. Furthermore, the foregoing description of the preferred embodiment of the invention and the best mode of practicing the invention are provided for the purpose of illustration only and not for the purpose of limitation—the invention being defined by the claims.

What is claimed is:

1. A flavored sheet product adapted for being folded to create a three-dimensional design, said product comprising:
(a) a generally flat sheet of edible or chewable flavored substance having sufficient flexibility to be folded, and adapted for retaining the fold in a three-dimensional design; and
(b) indicia applied to said sheet indicating where the folds should be made in order to create the three-dimensional design.

2. A flavored sheet product according to claim 1, wherein the flavored substance comprises chewing gum.

3. A flavored sheet product according to claim 1, wherein the flavored substance comprises a food product.

4. A flavored sheet product according to claim 1, wherein said indicia comprises a printed fold line.

5. A flavored sheet product according to claim 4, wherein said fold line is broken.

6. A flavored sheet product according to claim 4, wherein said fold line is solid.

7. A flavored sheet product according to claim 1, wherein said indicia comprises a screen print.

8. A flavored sheet product according to claim 1, wherein said indicia comprises a press print.

9. A flavored sheet product according to claim 1, wherein said indicia comprises edible ink.

10. A flavored sheet product according to claim 1, wherein said indicia comprises a character face.

11. A flavored sheet product according to claim 1, wherein said sheet comprises a die cut to facilitate folding.

12. A flavored sheet product adapted for being folded to create a three-dimensional design, said product comprising:
(a) a generally flat sheet of chewable flavored substance having sufficient flexibility to be folded, and adapted for retaining the fold in a three-dimensional design;
(b) indicia applied to said sheet indicating where the fold should be made in order to create the three-dimensional design; and
(c) a separate instruction sheet demonstrating the fold necessary to create the three-dimensional design.

13. A flavored sheet product according to claim 12, wherein the flavored substance comprises chewing gum.

14. A flavored sheet product according to claim 12, wherein the flavored substance comprises a food product.

15. A flavored sheet product according to claim 12, wherein said indicia comprises a printed fold line.

16. A flavored sheet product according to claim 15, wherein said fold line is broken.

17. A flavored sheet product according to claim 15, wherein said fold line is solid.

18. A flavored sheet product according to claim 12, wherein said indicia comprises edible ink.

19. A flavored sheet product according to claim 12, wherein said indicia comprises a character face.

20. A flavored sheet product according to claim 12, wherein said sheet comprises a die cut to facilitate folding.
